(19) United States
(12) Patent Application Publication
(10) Pub. No.: US 2010/0313919 A1
(43) Pub. Date: Dec. 16, 2010

(54) TRANSPORTABLE APPARATUS FOR WINDING, DRYING AND HYGIENIZING FLUID PIPES FOR FOOD USE

(75) Inventor: Ruggero Todesco, Vas (BL) (IT)

Correspondence Address: EGBERT LAW OFFICES, 412 MAIN STREET, 7TH FLOOR, HOUSTON, TX, 77002, US

(73) Assignee: ART ACCIAI srl, Alano di Piave (BL) (IT)

(21) Appl. No.: 12/483,989

(22) Filed: Jun. 12, 2009

(51) Int. Cl. B08B 9/023; B65H 65/00; B65H 54/02

(52) U.S. Cl. 134/166 C; 242/476.1

(57) ABSTRACT

Transportable apparatus for winding and hygienizing fluid pipes for food use, includes a support frame supporting a rotating drum, the rotating drum being constrained to a horizontal rotational shaft, supported by the frame. The rotational shaft is engaged to motion transmission means engaged with a ratio-motor integral with the frame of the apparatus. The rotating drum is subdivided into concentric frusto-conical and also intercommunicating sections, at least one of said frusto-conical sections being provided with a device for the engagement of at least one end of the corresponding pipe to be wound. A dispenser is joined to the apparatus for the distribution of a hygienizing solution inside the pipe. The control device of the movement of the rotating drum, includes a logical unit, which controls the speed, the rotational direction of the drum and the rotational periods.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

This invention relates to a transportable apparatus for drying and hygienizing fluid pipes for food use.

2. Description of Related Art Including Information Disclosed Under 37 CFR 1.97 and 37 CFR 1.98.

The invention finds particular if not even exclusive application in the field of the wine-making and preservation processes, such as the treatment or processing of must and wine.

In principle, at some latitudes, in autumn it happens that at the end of the phase relative to the malolactic fermentation of the must, one or more siphon-off operations must then follow.

Synthetically, by the siphon-off operation, it is possible to affirm that such a phase has the purpose to remove the dreg and to air the wine, which with the oxygen comes to a series of chemical reactions of the phenolic substances, needed to stabilize the color and for the following maturation. During this period, the wine is placed in steel containers or in vitrified cement basins having more or less big dimensions, less often in wooden stows. Once introduced into said containers, the wine, according to the processing type, is moved several times from one container to the other passing through a possible clarification or filtering phase. Then it is ready to be bottled and sent for consumption, usually starting from the month of March.

Besides suitable pumps, in order to carry out the siphon-off phase in the cellars, flexible pipes for food use are usually used, which can have different diameters and also several sections. Generally speaking, said pipes necessary to connect the container containing the wine to be poured off to the empty container, are all provided with at least one connection, joint or connecting joint intended for such a purpose, which can be perfectly fit to the pouring opening of the wine, provided in the relative container, which is equipped with special slide-gate. Sometimes said pipes are very long and anyway they must cover a minimum distance between one container and the other, moreover said distance possibly even consisting of some dozens of meters.

Prior Art

The need to have pipes, which are therefore flexible, but which also have a wide development in length, presents obvious handling problems, both in the case in which one needs to prepare the cisterns for the siphon-off phase, and simply to store them away in a suitable way and in a proper room at the end of the use. Usually and according to the conventional techniques the handling is performed manually, so that one or more operators takes the pipes and first connects by means of the connection, connecting joint the first cistern and then the other one. Therefore it is not rare the case in which the pipe, often dragged due to its weight, tends to get dirty at least at the inlets, or it hardly transits in narrow spaces, hitting several times and often at the quick connection, a delicate device which noticeably must always ensure a good seal condition, without drawings of the liquid, wine.

A second problem concerns the hygienization and drying phase of the pipe. In principle, the pipes, both wetted by wine and also washed with water must be at least dried along the whole internal path and in a uniform way, between a stop and the other during a multiple use phase or simply to be stored away until their next use. At present this operation is performed horizontally hanging the pipes to the walls, mainly for space reasons and against the containers or cisterns, in such a way that the ends tend to be bent downwards. Time and ambient temperature will do the rest, leaving the water dropping from the pipe, until the pipe is completely dried.

The need to dry the inside of each single pipe prior to its re-use is connected to precise wine-making rules which impose, along the path of the pipe, the absence of humidity or liquid pockets, inside which molds, yeasts and bacteria can form, harmful for the following and correct processing and preservation of wine. In any case, though occasionally, and when not in use for long periods, the pipes must be washed and successively internally treated with chemical solutions aimed at the complete removal of the bacterial receptacles and of any other thing which could be present inside the pipe and harmful for wine-making.

Therefore the problem raised of how to wind the pipes, in such a way as to easily move and store them, and at the same time of how to proceed to dry and hygienize their inside in such a way as not to use external devices.

Prior Art Closest to the Invention

Patent literature does not offer particular reference starting points. In particular, from a search performed on conventional databases numerous recurrences are traced concerning apparatuses or devices for winding mainly cables but also pipes mainly not intended for the food sector. In principle, said apparatuses consist of a spiral winding or unwinding reel, electro-power operated, predominantly connected to upstream or downstream installations for the following processing of the product wound or unwound in this way, generally integrated in a production or processing line of a product. The movement of the winding-unwinding reel can also be of the type controlled by an electronic card, which interacts with a logic unit managing the whole installation.

For example, KR930008673B (HYONG-CHAN) describes a winding device for a thermoplastic pipe, which contains a guide, a coil rotating around a central shaft, a cylinder.

EP0049552 (De Mos) proposes an apparatus for winding a spiral pipe. It consists of a bench, on which two rotational horizontal shafts of two relative winding reels are mounted.

GB2337508 (Renton) suggests a rotating winder for cables or pipes. It essentially consists of a pivoting hollow drum or cylinder supported by an axis during the rotation. It is provided with a central opening, through which a first tube end passes through to lie inside the wall of the drum during the winding.

EP1657202 (Fleckenstein) describes a transportable winder for small sized pipes. It is of the type provided with a frame with supporting handle for a winding drum around which the pipe is manually wound.

It is therefore reasonable to consider as known:
pipes for food use intended for the processing and treatment of wine, provided with quick connections at one or both ends for the connection to cisterns and/or to an analogous pipe section;
an unwinding-winding reel, power-operated or not, provided with a rotating drum around which the pipe or the cable is wound;
winding reel which is not transportable for large sized food pipes and which is manually transportable for small sized pipes;
a winding reel for small sized pipes, for example the one for water-hoses, to which a pipe end is engaged; and
a control device of the rotation of the winding reel.

Drawbacks

From everything stated above, according to the applicant the problems of the traditional techniques do not solve in an adequate way the above pointed out problems. In particular, in the field of wine processing and treating, as in the wine-making processes, the movement of the pipes still has reasonable problems, as well as their storage hardly occurs in a rapid and rational way.

Secondarily, concerning the need to dry the inside of the pipes, it is carried out with big difficulties, also and by effect of the climate usually present inside the cellars, which is notoriously humid, at least requiring long periods and a suitable positioning. In any case it is reasonable to suppose that anyhow inside the pipes, because of the incorrect drying phase, humid zones are still present, with the consequent formation of pockets of bacterial and fungal proliferation in the condensation accumulated along the walls, these being aspects that noticeably are particularly harmful and can compromise the correct wine-making process.

A third and further aspect refers to the hygienization phase which is still today necessarily performed manually due to the size of the pipes, supposedly in a not-effective way. This is due to the fact that the operator, who is obliged to manually handle them to facilitate the distribution of the hygienizing solution, does not have proper ambient height and space, therefore even if with a certain expertise, he cannot reasonably perform this phase in a uniform way. In any case, at the end of the washing with the hygienizing solution, the above pointed out problems are still present relative to the conventional drying phase.

Therefore companies and operators in the field reasonably need to find innovative solutions which are better in terms of quality as a whole with respect to the previous ones.

The aim of this invention is also to avoid the above-mentioned drawbacks.

### BRIEF SUMMARY OF THE INVENTION

This and other aims are reached with this invention according to the characteristics as per the included claims solving the above mentioned problems by means of a transportable apparatus for winding and hygienizing fluid pipes for food use, consisting of a support frame supporting a rotating drum, said rotating drum being constrained to a horizontal rotational shaft, supported by said frame, wherein said rotational shaft is engaged to motion transmission means engaged with a ratio-motor integral with the frame of the apparatus. The rotating drum is subdivided into concentric frusto-conical and also intercommunicating sections, at least one of said frusto-conical sections being provided with means for the engagement of at least one end of the corresponding pipe to be wound. A dispenser is joined to the apparatus for the distribution of a hygienizing solution inside the pipe. The control device of the movement of the rotating drum, consisting of a logical unit, which controls the speed, the rotational direction of the drum and the rotational periods.

Aims

In this way, by the considerable creative contribution the effect of which constitutes immediate technical progress, various aims and advantages are achieved.

A first aim, consisted in easily solving the problem of the storage of the pipe. In particular with the solution object of this invention, one or more pipes, also having different diameter and length, can be conveniently spirally wound and supported by the apparatus, which is provided with underlying wheels, possibly of the power operated type, to be easily transported, with little effort from one place to another.

A second aim is relative to the fact of being able to completely and uniformly dry the used pipe, optimizing the timetable and even without the intervention of operators. In this case, thanks to the control device, once hooked to the apparatus the pipe will be wound from time to time according to a desired period or, if power operated, according to a cycle set of the control logic unit, causing the fluid to slowly and progressively flow down by gravity towards the part corresponding to the unwound end of the pipe. The complete drying of the inside of the pipe allows to avoid the formation of pockets of bacterial, mold and yeast proliferation improving at least considerably the quality of the wine processing and treatment and of the wine-making process.

Providing a dispenser associated to the apparatus, provided with a hygienizing solution, makes the treatment of the pipe more comfortable and allows a much uniform distribution of the solution.

These and other advantages, which allowed the embodiment of an apparatus with a good technological content, will appear from the following detailed description of a preferred solution with the aid of the enclosed schematic drawing whose execution details are not to be considered restrictive but only and exclusively illustrative.

### BRIEF DESCRIPTION OF THE SEVERAL VIEWS OF THE DRAWINGS

FIG. 1 represents a front elevational view of the apparatus object of this invention.

FIG. 2 represents a cross-sectional view of the apparatus of FIG. 1.

FIG. 3 is an elevation view from the back of the apparatus of the previous figures.

FIG. 4 is a side elevation view of the apparatus of the previous figures.

### DETAILED DESCRIPTION OF THE INVENTION

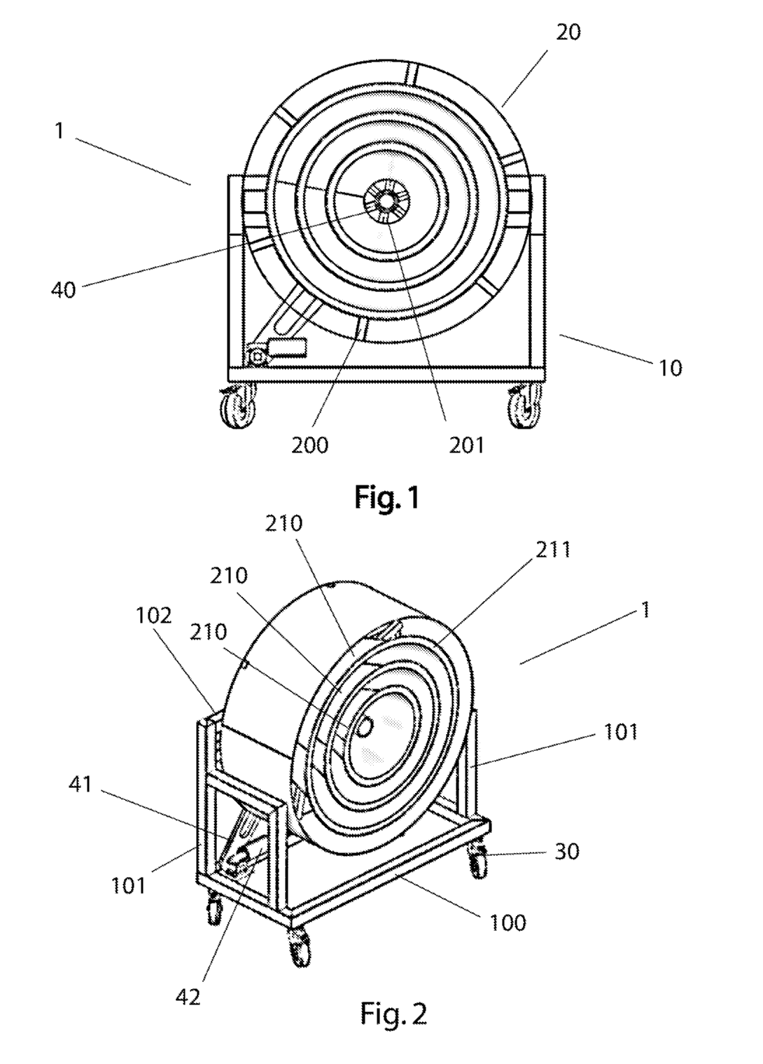

With reference to the figures as well, one can observe that a transportable apparatus 1 for winding, drying and hygienizing fluid pipes for food use, consists of a metallic frame 10 and a drum 20 (FIG. 1). The frame 10 includes a horizontal base 100, two shoulders 101 respectively, a right shoulder and a left shoulder facing one another, and a back 102 which are orthogonal with respect to the base 100, in such a way as to define on three sides a housing seat of the drum 20 which is in a vertical position and frontally open (FIG. 1). At the base 100, on the lower side, casters-wheels 30 are engaged at the four corners, provided with a stop device. Alternatively at least one of the wheels 30 can be moved by an autonomous motor group, supplied by a proper accumulator joined to the frame 10 of the transportable apparatus 1, possibly also provided with handles or tow hook if necessary.

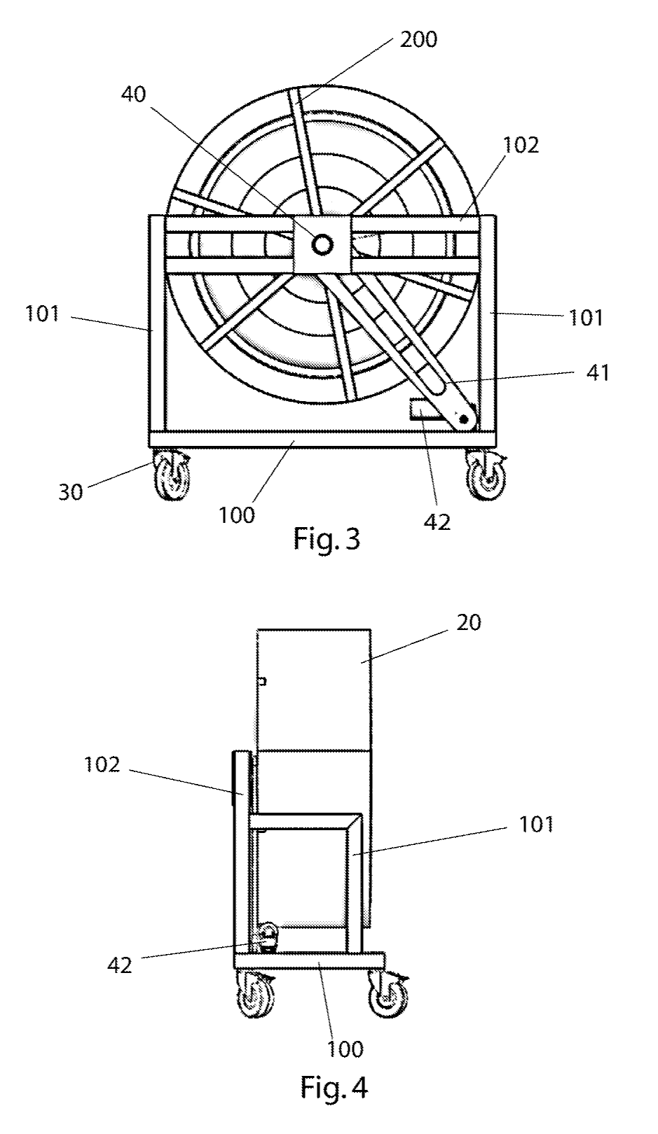

The drum 20 is joined with respect to the frame 10 by means of the horizontal rotational shaft 40 (FIG. 3) which supports it. In more detail, the rotational shaft 40 is hinged in correspondence of the back 102 of the frame 10 and in turn the drum 20 is keyed in a removable way to the rotational shaft 40. More particularly, on the back side against the back 102 of the frame 10, the drum 20 consists of six radial arms 200 with the end 201 joined to the rotational shaft 40. Some concentric frusto-conical sections 210 (FIG. 2) are orthogonally joined to the radial arms 200, the number of said concentric frusto-conical sections being three, shaped as a funnel directed towards the back 102 and open in correspondence of the front end (FIGS. 1 and 2). Each frusto-conical section 210 is made in such a way as to be provided along the front end (FIG. 1) with a perimetrical lip 211 which constitutes a panel retaining the pipe which is wound to at least one frusto-conical section 210.

The rotational shaft 40 can be manually induced to rotate by means of a crank (not illustrated) which operates in cooperation with proper devices for the transmission and reduction of the motion or which operates in an autonomous way. In the latter case the rotational shaft 40 receives the movement by a chain transmitting gear 41 which is housed inside a housing protection engaged against the back 102 of the frame 10. In this case the chain transmitting gear 41 receives in turn the movement through a ratio-motor 42 which is joined to the frame 10 at the base 100, said ratio-motor 42 being able to be supplied both by conventional power supply mains and by means of a proper accumulator.

To allow the pipe winding, along the wall of each frusto-conical section 210 hooking means are provided to engage a first end of the two ends of the pipe to be wound. In this way, the drum 20, rotating due to the rotational motion impressed to the shaft 40 by the ratio-motor 42, provides the winding of the interested pipe, at least to one frusto-conical section 210 pulling its second end opposite the first one, which remains at a lower height, in such a way that the liquid contained inside the pipe will flow down by gravity towards said second end.

The ratio-motor 42 is of the type controlled by a logical unit, whose control card contains at least one preset cycle to wind the pipe, wherein said cycle is modifiable in relation to the winding parameters, and in particular relatively to rotation direction, speed and winding period-cycle, in addition to the traditional turning on-off keys. By means of said control card or manual unlocking mechanism it is furthermore possible to disengage the ratio-motor 42, in such a way as to be able to accomplish the winding phase in a manual way as well.

Finally a proper dispenser (not shown) can be joined to the frame 10 of the apparatus 1 for the distribution of the hygienizing solution in such a way as to allow the flushing of the inside of the pipe in a wound condition or prior to the winding phase.

### REFERENCE

1 transportable apparatus

10 metallic frame

20 drum

100 horizontal base

101 shoulders

102 back

30 wheels

40 rotational shaft

200 radial arms

201 radial arm end

210 frusto-conical sections

211 perimetrical lip

41 transmitting gear

42 ratio-motor

1. Transportable apparatus for winding and hygienizing fluid pipes for food use, the apparatus comprising:
a support frame; and
a vertical rotating drum, said rotating drum being supported by said support frame and constrained to a rotational shaft, said rotational shaft being supported by said support frame, the drum being subdivided into concentric frusto-conical sections, at least one frusto-conical section being provided with means for engaging at least one end of the corresponding pipe to be wound.

2. Transportable apparatus for winding and hygienizing fluid pipes for food use according to claim 1, wherein said rotational shaft is engaged to transmission means of the motion engaged to a ratio-motor integral with the support frame.

3. Transportable apparatus for winding and hygienizing fluid pipes for food use according to claim 2, said ratio-motor moving the drum being controlled by a logical unit, said logical unit having a control card containing at least one preset cycle for winding, wherein said cycle is modifiable in relation to the relative winding parameters, such as rotation direction, speed and the winding period-cycle, besides turning on-off keys.

4. Transportable apparatus for winding and hygienizing fluid pipes for food use according to claim 1, wherein the support frame comprises a horizontal base, two shoulders respectively, a right shoulder and a left shoulder facing each other, and a back, the shoulders and back being orthogonal with respect to the base, defining on three sides a housing seat of the drum, the drum being in a vertical position and frontally open, and wherein, at the base, on the lower side, wheels are engaged at the four corners, provided with a stop device.

5. Transportable apparatus for winding and hygienizing fluid pipes for food use according to claim 4, wherein at least one of the wheels is actuated by an autonomous motor group.

6. Transportable apparatus for winding and hygienizing fluid pipes for food use according to claim 1, further comprising:
a dispenser for distribution of hygienizing solution, being joined to the frame and allowing the flushing of the inside of the pipe in a wound condition or prior to the winding phase.
